(19) United States
(12) Patent Application Publication
(10) Pub. No.: US 2023/0027283 A1
(43) Pub. Date: Jan. 26, 2023

(54) METHOD AND SYSTEM FOR COORDINATED BEAM MANAGEMENT IN WIRELESS VEHICULAR COMMUNICATION

(71) Applicants: HYUNDAI MOTOR COMPANY, Seoul (KR); Kia Corporation, Seoul (KR)

(72) Inventors: Michele RONDINONE, Frankfurt am Main (DE); Baldomero COLL PERALES, Beniel (Murcia) (SP)

(73) Assignees: HYUNDAI MOTOR COMPANY, Seoul (KR); Kia Corporation, Seoul (KR)

(21) Appl. No.: 17/490,795

(22) Filed: Sep. 30, 2021

(30) Foreign Application Priority Data
Jul. 26, 2021 (DE) 102021208030.8

(51) Int. Cl. H04W 4/46; H04W 16/28

(52) U.S. Cl. CPC H04W 4/46; H04W 16/28

(57) ABSTRACT

A method for coordinated beam management in wireless vehicular communication comprises initiating an omnidirectional broadcast transmission by a transmitting vehicle towards a group of receiving vehicles, wherein the transmission is addressed to all receiving vehicles simultaneously; performing a beam steering process by each of the receiving vehicles to identify a directional communication beam pointing from the respective receiving vehicle towards the transmitting vehicle; and communicating data via the initiated omnidirectional broadcast transmission from the transmitting vehicle to the receiving vehicles over a transmission time period, wherein the receiving vehicles maintain their respective directional communication beam over the transmission time period in order to receive the transmitted data via the respective directional communication beam.

### TECHNICAL FIELD

The present disclosure pertains to a method and a system for coordinated beam management in wireless vehicular communication as well as to vehicles with such a system.

### BACKGROUND

Modern cars are increasingly equipped with wireless communication devices, in particular for vehicle-to-everything (V2X) communication, on which basis information may be communicated from a vehicle to any entity that may affect the vehicle or that may be affected by it. Such a vehicular communication system may incorporate other more specific types of communication, in particular V2V communication, that is, wireless vehicle-to-vehicle communication. V2X technology does not only improve traffic flow but may also help to make traffic safer and driving more convenient.

Today, basic safety-related V2X applications (e.g., emergency braking notification, collision avoidance) are often based on periodic broadcast exchange of small-sized messages including information on a vehicle's location, speed, acceleration, heading etc. For these applications V2X technologies with limited data rate (e.g., up to ˜10 Mbps) are normally used (e.g., IEEE 802.11p or LTE-V2X).

Cooperative advanced Driver Assistance Systems (ADAS) and future connected automated driving (CAD) applications will be based on exchange of higher amount of data, which in turn requires much higher data rates, e.g., (raw and/or processed) sensor data sharing, video sharing where follower vehicles receive real-time videos of a leading vehicle's camera etc. (cf., e.g., 3GPP TR 22.886 v16.20).

Millimeter Wave V2X (mmWave V2X) is an emerging technology addressing these requirements thanks to a significantly larger bandwidth. Images/raw sensor data can be shared with direct neighbors (1-hop) for this purpose. Receiving these data represents an added value to the support of advanced applications (e.g., automated reactions to prevent potentially risky situations). However, mmWave V2X is challenged by higher pathloss at the adopted high-frequency bands (30-300 GHz).

This may be compensated by using highly directional unicast transmissions, wherein radio power is concentrated in the direction of a specific receiver. However, directional mmWave unicast transmissions imply higher delays for a vehicle to share its data to all the neighboring vehicles, as each individual neighbor needs to be sequentially addressed/contacted across each antenna beam. Hence, for each transmitter, the delay increases with the number of receiving neighbors. Therefore, the last addressed neighbors might receive outdated information compared to the first ones. At a network level (considering that all vehicles need to share local data to neighbors), the reception delay may increase exponentially since each transmitter has to wait for its neighbors to complete their sequential unicast transmissions. This may affect the effectiveness of advanced cooperative ADAS and CAD applications at receiving vehicles, because they may get less-frequent data updates from transmitters.

Document U.S. 2020/0045664 A1 teaches to use an omnidirectional communication scheme to establish contact between vehicles if possible. However, if no response is received by the transmitting vehicle from the receiving vehicle within the omnidirectional scheme, then the transmitting vehicle uses, at sequential attempts, a directional transmission configuration of increasing granularity to have higher chances to reach the receiving vehicle. This in turn might imply delays in data reception at the addressed vehicles when multiple receiving vehicles are considered.

The information disclosed in the Background section above is to aid in the understanding of the background of the present disclosure, and should not be taken as acknowledgement that this information forms any part of prior art.

### SUMMARY

Hence, there is a need to find solutions for sharing high amounts of data using directional communications that do not cause reception delays at the addressed vehicles.

To this end, the present disclosure provides a method in accordance with claim 1, a wireless vehicular communication system in accordance with claim 7 and a motor vehicle in accordance with claim 13.

According to one aspect of the present disclosure, a method for coordinated beam management in wireless vehicular communication includes initiating an omnidirectional broadcast transmission by a transmitting vehicle towards a group of receiving vehicles, wherein the transmission is addressed to all of the receiving vehicles simultaneously; performing a beam steering process by each of the receiving vehicles to identify a directional communication beam pointing from the respective receiving vehicle towards the transmitting vehicle; and communicating data via the initiated omnidirectional broadcast transmission from the transmitting vehicle to the receiving vehicles over a transmission time period, wherein each of the receiving vehicles maintains the respective directional communication beam over the transmission time period in order to receive the transmitted data via the respective directional communication beam.

According to another aspect of the present disclosure, a wireless vehicular communication system for a vehicle includes a communication device configured to perform a beam steering process to identify a directional communication beam pointing from the vehicle towards a transmitting vehicle and to maintain the directional communication beam over a transmission time period in order to receive data via the directional communication beam from the transmitting vehicle, and to initiate an omnidirectional broadcast transmission towards a group of receiving vehicles, wherein the omnidirectional broadcast transmission is addressed to all of the receiving vehicles simultaneously, and to communicate data via the initiated omnidirectional broadcast transmission to the receiving vehicles over a transmission time period.

According to yet another aspect of the present disclosure, a motor vehicle includes a wireless vehicular communication system described above.

One idea of the present disclosure is to simplify procedures for data sharing with other vehicles by using a coordinated mixed antenna configuration and broadcast-like transmissions. The transmitter uses an omnidirectional antenna setup while the receivers set their antennas in directional mode pointing towards the transmitter. The combination of omnidirectional setup at transmitter side and directional setup at receiver side compensates potential path loss and favors data reception, in particular at short distances. Using broadcast transmissions in this scenario reduces the delay at the receiving side. The delay reduction compared to traditional unicast and directional solutions increases as the number of receiving neighbors increases, especially considering the “global” network perspective where all vehicles share their data. As a consequence, the present disclosure may turn out to be a key enabler for future advanced cooperative ADAS and CAD applications.

Before starting to receive data, neighboring vehicles need to complete the beam steering process to identify the beam pointing towards the transmitter. However, with the present approach the beam steering process needs to be executed only by the receivers and not the transmitter, which makes the present system faster and simpler. Contrary to this, the traditional approach requires both of transmitter and receivers to perform it.

The transmitter may initiate a broadcast-like transmission at time t for a duration of T seconds. In the coordinated mixed antenna configuration of the present disclosure for data sharing between transmitter and receivers the transmitter then sets its antenna(s) at time t in omnidirectional mode and all neighbors select the beam that is pointing towards the transmitter (thanks to previously performed beam steering). The neighbors keep the beam pointing towards the transmitter for T seconds until transmission is completed. At t+T, another neighbor may then start a broadcast-like transmission.

As a consequence, reception delay is reduced, and high amounts of data can be shared in vehicle-to-vehicle communication scenarios. Considering one transmitter sharing its data (local-level perspective), the disclosure allows all the receiving neighbors to get always up-to-date information. Considering multiple transmitters sharing data (network-level perspective), the disclosure allows saving communication time that can be reused by the entire vehicular network for increasing the frequency of data exchange between all vehicles. As a result of getting more frequent and up-to-date data, receivers are enabled to implement more reliable/performing advanced cooperative ADAS and CAD applications.

In the present disclosure, an omnidirectional antenna is an antenna that radiates or receives radio power in all directions equally. Correspondingly, an omnidirectional transmission is a transmission performed towards all directions. On the contrary, a directional antenna is an antenna which radiates or receives radio power in a specific direction and a directional transmission is a transmission performed towards a specific direction. Concentrating the same amount of power in specific directions, directional antenna configurations allow transmitting or receiving at higher distances compared to using omnidirectional configurations.

Within the meaning of the present disclosure, a beam relates to the direction along which a directional antenna concentrates (i.e., radiates or receives) power.

Unicast (one-to-one) refers to transmissions addressed specifically to one receiver, while broadcast (one-to-all) is a transmission addressed to all receivers simultaneously. Or, in other words, broadcast refers to a content that is not addressed to a particular vehicle (i.e., unicast) but to all vehicles that receive it. In principle, a broadcast transmission could be omnidirectional (i.e., radiated in all directions) or directional (i.e., radiated in a particular direction).

Path loss (or path attenuation) relates to degradation/attenuation (reduction in power level) of radio signals as they propagate through space.

Beam steering is a process by which the transmitter and/or the receiver identify the beams pointing towards each other to later perform the transmission. It involves a procedure in which the antenna of one party is set to directional mode and sequentially scans different sectors to identify the beam pointing at the other party, wherein the number of sectors can vary, e.g., 10 sectors or more for 360 degree coverage. Beam steering is thus performed in order to focus energy towards a particular direction.

It is understood that the term “vehicle” or “vehicular” or other similar term as used herein is inclusive of motor vehicles in general such as passenger automobiles including sports utility vehicles (SUV), buses, trucks, various commercial vehicles, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, a vehicle that has both of gasoline-power and electric-power.

Advantageous embodiments and improvements of the present disclosure are found in the subordinate claims.

According to an exemplary embodiment of the disclosure, the vehicles may use Millimeter Wave V2X communication for transmission and reception.

Millimeter Wave (mmWave) V2X is a radio communication technology using electromagnetic waves in the frequency band ranging from 30 GHz to 300 GHz. It allows transmissions of higher amount of data in a relatively short time (high data rate), but may suffer from higher path loss compared to V2X technologies using lower frequency bands (like e.g., IEEE 802.11p or LTE-V2X operating below 6 GHz).

According to one aspect of the present disclosure, the relatively higher data rate of mmWave V2X may be utilized in spite of the relatively higher path loss. In the present case, only the mmWave transmitter sets the antenna in omnidirectional mode to perform the transmission for data sharing. The receiver(s) set its (their) antenna(s) in directional mode pointing towards the transmitter. In this case, the mmWave transmitter can communicate with all the mmWave receivers simultaneously with single transmission. The antenna configuration of the mmWave receivers in directional mode provides the additional gain to compensate the propagation losses at mmWave frequencies.

According to an exemplary embodiment of the present disclosure, communication may be established between neighboring vehicles.

The combination of the present disclosure of omnidirectional and directional setup at transmitter and receiver side, respectively, provides particular benefits at short distances and/or under line-of-sight conditions between direct neighbors (1-hop from the transmitting vehicle) where it better compensates the path loss and favors data reception.

According to an exemplary embodiment of the present disclosure, the transmission time period may be a fixed and/or predefined time period.

For example, the transmission time period may be agreed upon in advance between all participants of the communication scheme and may be set to an adequate time interval suitable for typical everyday situations.

Alternatively, it may however be beneficial to choose and set the time interval dynamically depending on the use case and the specific situation.

According to an exemplary embodiment of the present disclosure, each of the receiving vehicles may be coordinated in advance with other vehicles, one of which is the transmitting vehicle, by using a sub-6 GHz V2X technology. In particular, IEEE 802.11p and/or LTE-V2X may be utilized for this purpose.

By scheduling a coordinated access for the mmWave channel(s), the present approach may prevent that more vehicles transmit at the same time and potentially interfere with each other. Such a coordination can be performed using other dedicated short-range to medium-range communication technologies that do not offer the large bandwidth and high data rates of mmWave V2X but may have benefits in case that only small amounts of data need to be exchanged.

According to an exemplary embodiment of the present disclosure, the communicated data may include sensor data, image data and/or video data.

In general, the communicated data may include any enriched data generated within a vehicle that can be used to support cooperative ADAS and CAD applications. Sensor data may include raw and/or processed sensor data. While in traditional mmWave schemes omnidirectional broadcast modes may have been used for sharing control information (scheduling, beam steering etc.), the present disclosure uses this omnidirectional broadcast mode to serve the demands of cooperative ADAS and CAD applications with regards to high data rates such that (raw and/or processed) sensor data, video streams and similar may be shared between neighboring vehicles. For example, a vehicle may transmit a video stream of its front and/or rear cameras to a trailing vehicle and/or to a leading vehicle (simultaneously), which thus are able to receive live camera images and video feed in real time from the transmitting vehicle.

The inventive concept(s) of the present disclosure will be explained in greater detail with reference to exemplary embodiments depicted in the drawings as appended.

### BRIEF DESCRIPTION OF THE DRAWINGS

The accompanying drawings are included to provide a further understanding of the present disclosure and are incorporated in and constitute a part of this specification. The drawings illustrate the embodiments of the present disclosure and together with the description serve to explain the principles of the disclosure. Other embodiments of the present disclosure and many of the intended advantages of the present disclosure will be readily appreciated as they become better understood by reference to the following detailed description. The elements of the drawings are not necessarily to scale relative to each other. In the figures, like reference numerals denote like or functionally like components, unless indicated otherwise.

FIG. 1 schematically depicts an example for a wireless communication between vehicles where all vehicles adopt omnidirectional antenna configurations for transmitting and receiving.

FIG. 2 schematically depicts another example for a wireless communication between vehicles where all vehicles adopt directional antenna configurations for transmitting and receiving.

FIG. 3 schematically depicts a wireless communication between vehicles based on coordinated beam management according to an exemplary embodiment of the present disclosure.

FIG. 4 shows a flow diagram of a corresponding method for coordinated beam management in line with FIG. 3.

FIG. 5 shows a sequence table for data exchange over time for the example of FIG. 2 for an increased number of vehicles.

FIG. 6 shows a sequence table for data exchange over time for the embodiment of FIG. 4 for an increased number of vehicles.

Although specific embodiments are illustrated and described herein, it will be appreciated by those of ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

### DETAILED DESCRIPTION OF THE EMBODIMENTS

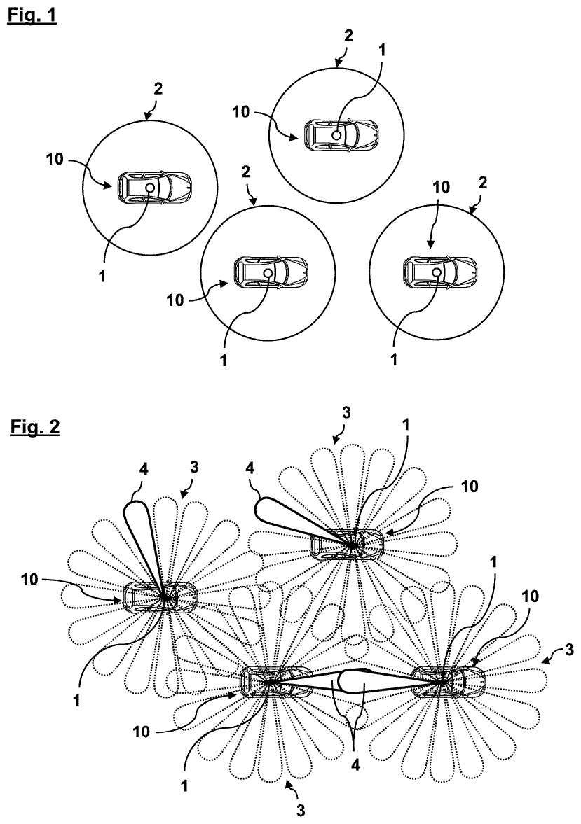

FIG. 1 schematically depicts an example for a wireless communication between vehicles 10.

FIG. 1 represents an example for a very simple approach to share data between multiple vehicles 10 at once. Such a sharing of data is based on omnidirectional broadcast transmissions 2 where both of the transmitter and the receiver(s) set the antennas of their respective communication devices 1 in omnidirectional mode. At mmWave frequencies, however, the range of the communication when both of the transmitter and the receiver(s) are in omnidirectional mode would be relatively low in this example, because mmWave V2X would suffer significant path losses in omnidirectional mode. This is illustrated by the diameter of the transmission 2 circles in FIG. 1, which indicates that the range of the transmission 2 is not large enough for the vehicles 10 to communicate with each other. Thus, in this example, the receiver(s) may not be able to receive the messages transmitted by the mmWave transmitter when using mmWave V2X.

FIG. 2 schematically depicts another example for wireless communication between vehicles 10.

For the reasons explained with reference to FIG. 1, mmWave communications are commonly based on directional transmissions 3 as shown in FIG. 2 in order to compensate the high propagation losses at mmWave frequencies. In this case, the antennas of the communication devices 1 of the vehicles 10 serving as mmWave transmitter and/or receiver need to be pointing towards each other. The orientation of the transmission of the respective devices 1 is indicated in FIG. 2 by the direction of the directional communication beams 4. As can be seen in FIG. 2, the two lower right vehicles 10 have their beams aligned and can now share data between each other.

However, in order for one vehicle 10 to share its data with all other vehicles 10, the communication device 1 of the one vehicle 10 with its mmWave transmitter would need to sequentially contact all of neighboring vehicles 10 one after the other. This would improve the issue with the propagation losses at mmWave frequencies from the example of FIG. 1, but would add significant delays to the mmWave communication due to the sequential ordering of the transmissions 3.

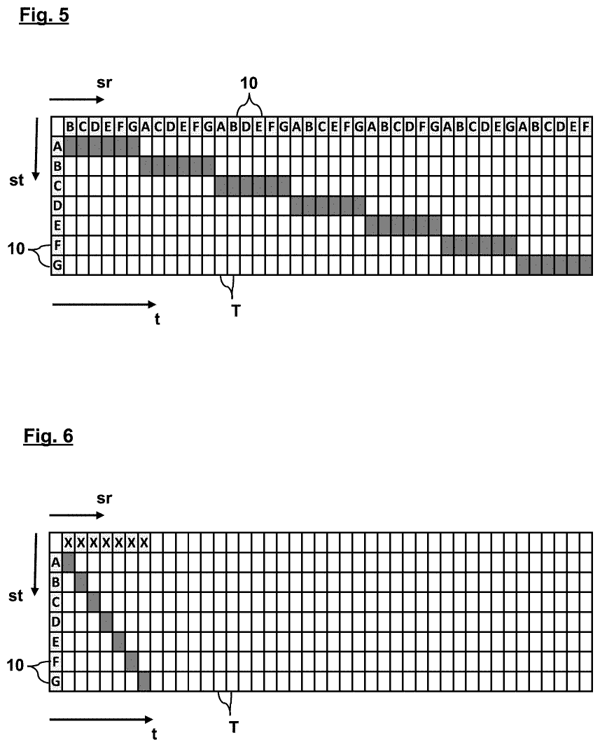

The above problem is illustrated with reference to FIG. 5, which depicts the reception delay arising with the procedure of FIG. 2 for an increased number of vehicles. In the scenario of FIG. 5, overall seven vehicles 10 want to share their data with each other. Vehicle A starts in the uppermost row by sequentially contacting vehicles B to G one after the other (following the first row to the right). Each box represents a transmission interval required to transfer the data from one vehicle 10 to another. The time required for transferring the data is a transmission time period T. Only when vehicle A has finished transmitting its data to all other vehicles B to G, vehicle B may start as a next vehicle, processing again all other vehicles A, C to G one after the other (second row in FIG. 5). In a similar vein, vehicles C to G transmit their data to all respective other vehicles individually. The procedure is finished at the right end of the last row in FIG. 5.

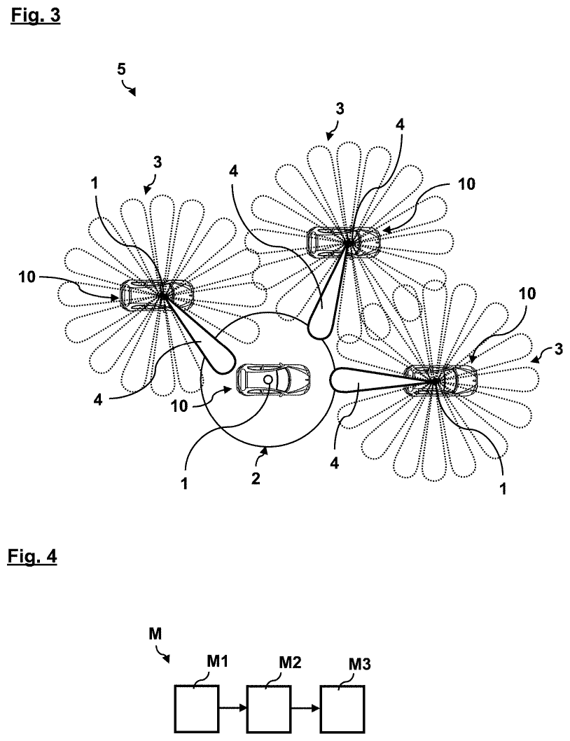

Regarding FIG. 3, a wireless communication between vehicles 10 based on coordinated beam management according to an exemplary embodiment of the disclosure follows a new approach. In this case, only the mmWave transmitting vehicle 10 (lower left vehicle 10 in FIG. 3) sets the antenna of its communication device 1 in omnidirectional mode to perform the transmission for data sharing. The receiving vehicles 10 on the other hand set their antennas in directional mode pointing towards the transmitting vehicle 10. In this case, the mmWave transmitter can communicate with all the mmWave receivers with a single transmission. The antenna configuration of the mmWave receivers in directional mode provides the additional gain to compensate the propagation losses at mmWave frequencies.

More specifically, a corresponding method M for wireless mmWave V2X communication as depicted in FIG. 4 comprises, under the step M1, initiating an omnidirectional broadcast transmission 2 by a transmitting vehicle 10 towards a group of neighboring receiving vehicles 10 under line-of-sight conditions. In doing so, the transmission 2 is addressed to all receiving vehicles 10 simultaneously. The method M further comprises, under the step M2, performing a beam steering process by each of the receiving vehicles 10 to identify a directional communication beam 4 pointing from the respective receiving vehicle 10 towards the transmitting vehicle 10. The method M further comprises, under the step M3, communicating data via the initiated omnidirectional broadcast transmission 2 from the transmitting vehicle 10 to the receiving vehicles 10 over a transmission time period T. The receiving vehicles 10 maintain their respective directional communication beam 4 pointing towards the transmitting vehicle over the transmission time period T in order to receive the transmitted data via the respective directional communication beam 4. The transmission time period T may be fixed and/or predefined. Alternatively, the transmission time period T may be changed dynamically depending on the respective situation acting on the step M1.

Referring back to FIG. 3, the vehicle 10 in the lower left initiates its communication device 1 for transmitting in omnidirectional broadcast mode to all other vehicles 10 at the same time. Before the transmission can be started, the other vehicles 10 have to complete their individual beam steering procedure to find a suitable directional communication beam 4 pointing at the transmitting vehicle 10.

It is assumed in the above procedure that the vehicles 10 have agreed beforehand on which vehicle 10 is allowed to transmit its data first (in case that at least two vehicles 10 want to share their data with the other vehicles). Such a coordination can be performed, for example, using conventional data sharing technologies normally used for lower data rates (relatively speaking), e.g., IEEE 802.11p or LTE V2X or the like. In contrast, the mmWave V2X communication described with reference to FIGS. 3 and 4 can be used for relatively high data rates, as they may be required for advanced ADAS or CAD applications. Hence, the present system 5 may be used to transmit, for example, (raw and/or processed) sensor data, image data, video data and so on.

FIG. 6 demonstrates the advantage of the system 5 described above with reference to FIGS. 3 and 4. The figure shows a sequence table for data exchange over time for the embodiment of FIGS. 3 and 4 in a similar vein as FIG. 5, also with an increased number of overall seven vehicles.

As was described above, in the example of FIGS. 2 and 5, the transmitting vehicle, e.g., vehicle A, needs to contact all its neighbors, i.e., vehicle B, C, D, E, F and G. Using directional unicast transmissions, the transmitting vehicle A will need to address sequentially each of the neighbors using a different beam at subsequent instants. This leads to a higher delay to complete a communication cycle to all neighbors.

In the embodiment of FIGS. 3 and 4, the mmWave transmitting vehicle A also needs to contact all the neighbors (B to G). However, in this case the transmitting vehicle A uses a single omnidirectional mmWave broadcast transmission, and the neighboring vehicles B to G simultaneously use their respective beams pointing towards the mmWave transmitting vehicle A to receive the shared data. This leads to a lower delay as all neighbors receive data at the same time.

In FIG. 6, the respective group of receiving vehicles 10 that receive their data simultaneously is collectively marked as X. Hence, in case of transmitting vehicle A, the group X comprises vehicles B to G. As can be seen in FIG. 6, one complete round of data sharing is already finished in this approach after seven transmission time periods T. In contrast to this, the procedure in FIG. 5 takes seven times longer, which means that some vehicles 10 may receive data from the other vehicles 10 that is already outdated. The amount of time saved in the new approach of FIGS. 3 and 4 could be used, for example, to run more frequent data updates between the vehicles 10, thereby offering benefits for cooperative ADAS and CAD applications.

In sum, the present disclosure uses a mixed antenna configuration, where the transmitting vehicle 10 transmits broadcast-like in omnidirectional mode for a limited time period and the receiving vehicles 10 use beam steering to point their antennas within directional mode to the transmitting vehicle 10 to receive the broadcast transmission during that time period. As a consequence, reception delay can be reduced compared to known pure directional concepts for mmWave V2X (i.e., transmitter and receiver in directional mode) and the system can experience less path loss compared to pure omnidirectional concepts (i.e., transmitter and receiver in omnidirectional mode).

In the foregoing detailed description, various features are grouped together in one or more examples with the purpose of streamlining the disclosure. It is to be understood that the above description is intended to be illustrative, and not restrictive. It is intended to cover all alternatives, modifications and equivalents of the different features and embodiments. Many other examples will be apparent to one skilled in the art upon reviewing the above specification. The embodiments were chosen and described in order to explain the principles of the disclosure and its practical applications, to thereby enable others skilled in the art to utilize the disclosure and various embodiments with various modifications as are suited to the particular use contemplated.

### REFERENCE LIST

1 communication device
2 omnidirectional transmission
3 directional transmission
4 directional communication beam
5 wireless vehicular communication system
10 motor vehicle
t time
T transmission time period
st sequence of transmitting vehicles
sr sequence of receiving vehicles
X group of receiving vehicles
M method
M1-M3 method steps

What is claimed is:

1. A method for coordinated beam management in a wireless vehicular communication, the method comprising:
initiating an omnidirectional broadcast transmission by a transmitting vehicle towards a group of receiving vehicles, wherein the omnidirectional broadcast transmission is addressed to all of the receiving vehicles simultaneously;
performing a beam steering process by each of the receiving vehicles to identify a directional communication beam pointing from the respective receiving vehicle towards the transmitting vehicle; and
communicating data via the initiated omnidirectional broadcast transmission from the transmitting vehicle to the receiving vehicles over a transmission time period, wherein each of the receiving vehicles maintains the respective directional communication beam over the transmission time period in order to receive the transmitted data via the respective directional communication beam.

2. The method according to claim 1, wherein the receiving vehicles and the transmitting vehicle use Millimeter Wave V2X communication for transmission and reception.

3. The method according to claim 1, wherein a communication is established between neighboring vehicles.

4. The method according to claim 1, wherein the transmission time period is a fixed and/or predefined time period.

5. The method according to claim 1, wherein each of the receiving vehicles is coordinated in advance with other vehicles, one of which is the transmitting vehicle, by using a sub-6 GHz V2X technology including IEEE 802.11p and/or LTE-V2X.

6. The method according to claim 1, wherein the communicated data comprise at least one of sensor data, image data, or video data.

7. A wireless vehicular communication system for a vehicle comprising a communication device configured to:
perform a beam steering process to identify a directional communication beam pointing from the vehicle towards a transmitting vehicle, and maintain the directional communication beam over a transmission time period in order to receive data via the directional communication beam from the transmitting vehicle, and
initiate an omnidirectional broadcast transmission towards a group of receiving vehicles, wherein the omnidirectional broadcast transmission is addressed to all of the receiving vehicles simultaneously, and communicate data via the initiated omnidirectional broadcast transmission to the receiving vehicles over a transmission time period.

8. The wireless vehicular communication system according to claim 7, wherein the communication device is configured to use Millimeter Wave V2X communication for transmission and reception.

9. The wireless vehicular communication system according to claim 7, wherein the communication device is configured to establish a communication with neighboring vehicles.

10. The wireless vehicular communication system according to claim 7, wherein the transmission time period is a fixed and/or predefined time period.

11. The wireless vehicular communication system according to claim 7, wherein the communication device is configured to coordinate with other vehicles, one of which is the transmitting vehicle, by using a sub-6 GHz V2X technology including IEEE 802.11p and/or LTE-V2X.

12. The wireless vehicular communication system according to claim 7, wherein the communicated data comprise at least one of sensor data, image data, or video data.

13. A motor vehicle having the wireless vehicular communication system according to claim 7.
